(19) United States
(12) Patent Application Publication
(10) Pub. No.: US 2025/0163726 A1
(43) Pub. Date: May 22, 2025

(54) AUTOMATIC-ALARMING PUSH-DOWN TYPE EMERGENCY DOOR-LOCKING DEVICE

(71) Applicant: Shanghai Ming Wei Hardware Co., Ltd., Shanghai (CN)

(72) Inventor: Jung-Chung CHEN, Shanghai (CN)

(21) Appl. No.: 18/635,230

(22) Filed: Apr. 15, 2024

(30) Foreign Application Priority Data
Nov. 20, 2023 (TW) 112212575

(51) Int. Cl. E05B 45/06; E05B 65/10

(52) U.S. Cl. CPC E05B 45/06; E05B 65/1066; E05B 2045/0615; E05B 2045/0695

(57) ABSTRACT

An automatic-alarming push-down type emergency door-locking device, disposed at a door board, includes a main lock seat, a secondary lock seat, a push-down type handle assembly, a position-sensing module and an alarm module. The main and secondary lock seats are disposed at the door board, and the main lock seat has at least one locking element. In the push-down type handle assembly, a first handle and a second handle are connected pivotally with the secondary and main lock seats to be moved along a driving path from a locking position toward an unlocking position. At the locking or unlocking position, the locking element is buckled with or separated from the at least one locking groove. The position-sensing module transmits an alarm-triggering signal for the alarm module to generate an alarm, upon when the first handle leaves the locking position.

This application claims the benefit of Taiwan Patent Application Serial No. 112212575, filed on Nov. 20, 2023, the subject matter of which is incorporated herein by reference.

### BACKGROUND OF THE INVENTION

### (1) Field of the Invention

The invention relates to an emergency door-locking device, and more particularly to a push-down type emergency door-locking device that can be automatically alarmed while an unlocking operation is initiated.

### (2) Description of the Prior Art

In order for people to quickly escape from the building when an emergency disaster occurs, an emergency door and an emergency door lock are usually disposed at the escape exit. Due to the need for escape, it is often necessary to allow people in the room to quickly unlock and escape directly. However, as far as specific buildings are concerned, due to certain regulatory needs, people inside the building must meet certain conditions before they can be allowed to leave.

For example, when the interior of the building is a business space in a shopping mall, people inside the building must firstly complete the checkout actions before they can be allowed to leave. If some unscrupulous consumers leave through the emergency door without checking out after taking the goods, it will cause unreasonable property losses to the shopping mall.

Due to legal restrictions on escape priority, the door to theft is often wide open for unscrupulous consumers. As a result, shopping mall often has no choice but to allow them to steal and leave through the emergency door and suffer unreasonable losses. Generally, in order to prevent the occurrence of this situation, an alarm device is usually installed to issue an alarm when the escape exit is opened. For push-down emergency door-locking devices, since the main lock seat is usually installed with a driving component to drive the locking element to open and close the lock, the remaining internal space of the main lock seat is limited. In addition, to meet different internal spaces at different main lock seats, in the previous technology, it is usually necessary to install different sensing and alarm components (such as springs, strain gauges and buzzers) for different main lock seats, or choose to install the sensing and alarm components outside the corresponding lock seats and relevant strong housing for protection.

If installing different sensing and alarm components for different main lock seats is the choice, then it will inevitably cause the problem of increased preparation and installation costs of these sensing and alarm components. On the other hand, if installing the sensing and alarm components outside the main lock seats is the choice, then, since corresponding strong enough shells are needed to provide protection, it will also cause another increase in the preparation and installation costs of these sensing and alarm components.

### SUMMARY OF THE INVENTION

In view of the fact that, in the prior art, whether you choose to install different sensing and alarm components for different main lock seats, or choose to install the sensing and alarm components outside the main lock seats, additional expenses for the preparation of sensing and alarm components are inevitable. Accordingly, it is an object of the present invention to provide an automatic-alarming push-down type emergency door-locking device that can utilize a sparse room in a secondary lock seat to install components for sensing and alarming.

In the present invention, an automatic-alarming push-down type emergency door-locking device (the emergency door-locking device hereinafter) is disposed at a door board, and the door board includes a locking side neighboring to at least one locking groove. The emergency door-locking device includes a main lock seat, a secondary lock seat, a push-down type handle assembly, a position-sensing module and an alarm module.

The main lock seat, disposed by neighboring to the locking side of the door board, has at least one locking element. The secondary lock seat is disposed by being away from the locking side than the main lock seat. The push-down type handle assembly includes a first handle, a second handle and a push-down horizontal bar.

The first handle, connected pivotally with the secondary lock seat, is configured for being controlled to move pivotally toward an unlocking position along a driving path from a locking position. The second handle, connected pivotally with the main lock seat, is configured for being controlled to move with the first handle along the driving path. While at the locking position, the at least one locking element is buckled with the at least one locking groove. While at the unlocking position, the at least one locking element is separated from the at least one locking groove. The push-down horizontal bar bridges the first handle and the second handle so as to have the second handle and the first handle to be connected in a coherent manner.

The position-sensing module, disposed at the secondary lock seat, is configured for sensing whether or not the first handle has been separated from the locking position, and transmitting an alarm-triggering signal if positive. The alarm module, connected electrically with the position-sensing module inside the secondary lock seat, is configured for issuing an alarm upon when the alarm-triggering signal is received in a function-on state.

In one embodiment of the present invention, the first handle can include a first drive portion and a first operation portion. The first drive portion is disposed inside the secondary lock seat. The first operation portion is extended out of the secondary lock seat from the first drive portion, and connected fixedly with the push-down horizontal bar. The second handle can include a second drive portion and a second operation portion. The second drive portion is disposed inside the main lock seat. The second operation portion is extended out of the main lock seat from the second drive portion, and connected fixedly with the push-down horizontal bar. The position-sensing module includes a first micro-switch sensor for generating the alarm-triggering signal upon when it is detected that the first handle is separated from the locking position. The alarm module includes a circuit board, a controller and a buzzer. The circuit board is disposed inside the secondary lock seat. The controller is disposed at the circuit board, connected electrically with the position-sensing module, and configured for generating an alarm signal after the alarm-triggering signal is received in the function-on state. The buzzer, connected electrically with the controller, is to transmit an alarm after the alarm signal is received.

In addition, the emergency door-locking device can further includes an alarm on/off lock and an on/off position-detecting module. The alarm on/off lock, disposed inside the secondary lock seat, is driven by a key to move between a function-on position and a function-off position. The on/off position-detecting module is disposed at the secondary lock seat, connected electrically with the controller, and configured for transmitting a function-on signal to the controller for the controller to enter the function-on state upon when the alarm on/off lock is detected to be at the function-on position and for transmitting a function-off signal to the controller for the controller to enter a function-off state upon when the alarm on/off lock is detected to be at the function-off position, and then transmitting an alarm clear signal to the buzzer for terminating the alarm.

The on/off position-detecting module includes a second micro-switch sensor for detecting that the alarm on/off lock is at the function-on position or the function-off position.

As stated above, since the automatic-alarming push-down type emergency door-locking device provided in the present invention utilizes the position-sensing module disposed inside the secondary lock seat to sense if the first handle is separated from the locking position, such that the transmission of the alarm can be determined. In addition, since all the elements related to the aforesaid alarm means (including the position-sensing module and the alarm module) are disposed inside the secondary lock seat, and all the mechanisms related to the locking/unlocking are also disposed inside the main lock seat, thus functions of automatic sensing and alarming can be fulfilled without changing internal locking/unlocking mechanisms of the main lock seat. Accordingly, the applications can be common for a variety of existing push-down emergency door-locking devices, and thus the push-down emergency door-locking device originally without the alarm function can be upgraded to have the alarm function. Thereby, preparation and installation costs of the components related to the sensing and alarming can be substantially reduced.

All these objects are achieved by the automatic-alarming push-down type emergency door-locking device described below.

### BRIEF DESCRIPTION OF THE DRAWINGS

The present invention will now be specified with reference to its preferred embodiment illustrated in the drawings, in which:

FIG. 1 demonstrates schematically a preferred embodiment of the automatic-alarming push-down type emergency door-locking device in accordance with the present invention, installed behind an emergency door;

FIG. 2 is a schematic exploded view of the automatic-alarming push-down type emergency door-locking device of FIG. 1;

FIG. 3 is a schematic cross-sectional view of the automatic-alarming push-down type emergency door-locking device along line A-A of FIG. 1;

FIG. 4 is a schematic cross-sectional view of the automatic-alarming push-down type emergency door-locking device along line B-B of FIG. 1;

FIG. 5 is a schematic block view of internal main circuits of the automatic-alarming push-down type emergency door-locking device of FIG. 1;

FIG. 6 illustrates schematically the state of the automatic-alarming push-down type emergency door-locking device of FIG. 1 at a function on state of the alarm;

FIG. 7 illustrates schematically the state of the automatic-alarming push-down type emergency door-locking device of FIG. 1 at a controlled unlock state after being assembled behind the emergency door; and

FIG. 8 is a schematic cross-sectional view of the automatic-alarming push-down type emergency door-locking device along line C-C of FIG. 7.

### DESCRIPTION OF THE PREFERRED EMBODIMENT

The invention disclosed herein is directed to an automatic-alarming push-down type emergency door-locking device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

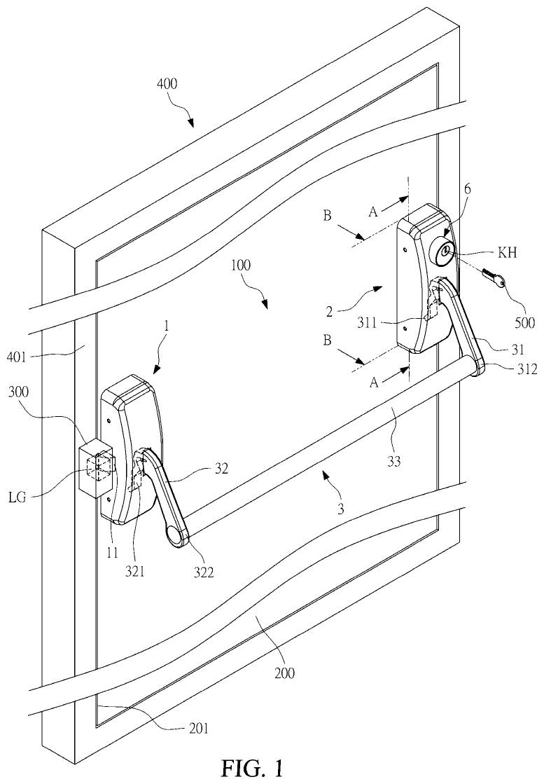

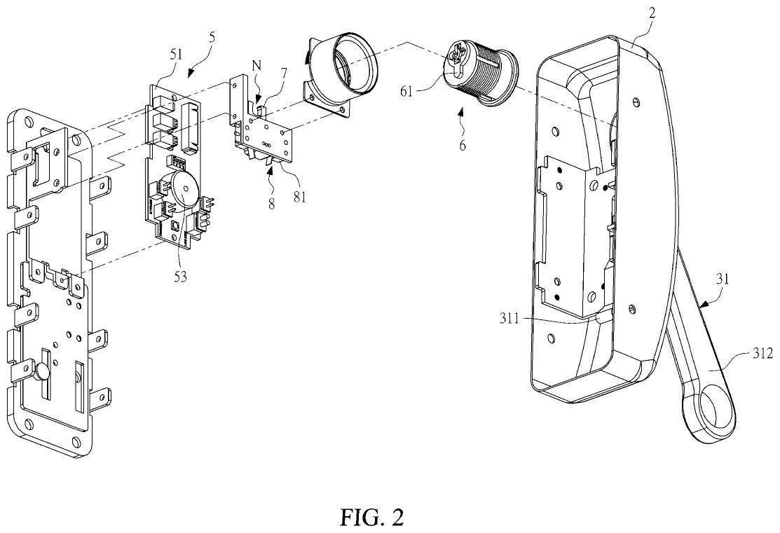

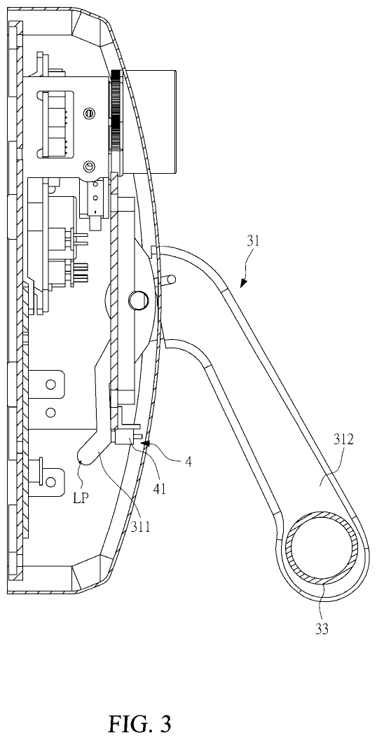

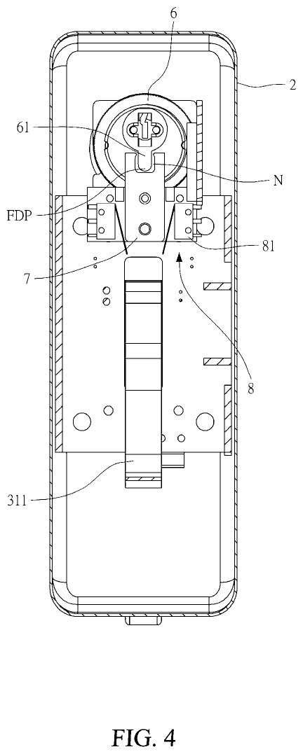

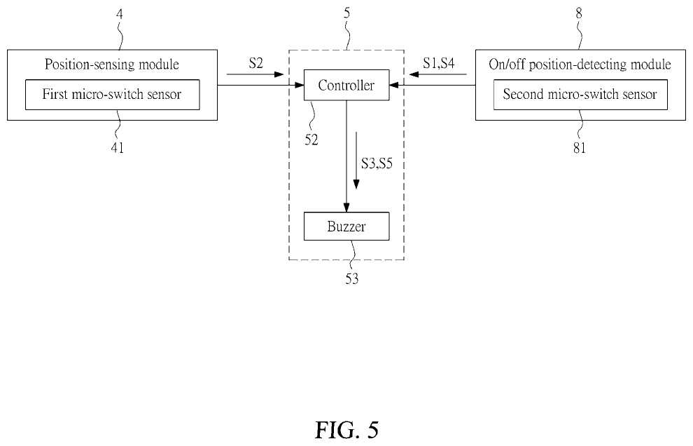

Refer to FIG. 1 to FIG. 5; where FIG. 1 demonstrates schematically a preferred embodiment of the automatic-alarming push-down type emergency door-locking device in accordance with the present invention, installed behind an emergency door, FIG. 2 is a schematic exploded view of the automatic-alarming push-down type emergency door-locking device of FIG. 1, FIG. 3 is a schematic cross-sectional view of the automatic-alarming push-down type emergency door-locking device along line A-A of FIG. 1, FIG. 4 is a schematic cross-sectional view of the automatic-alarming push-down type emergency door-locking device along line B-B of FIG. 1, and FIG. 5 is a schematic block view of internal main circuits of the automatic-alarming push-down type emergency door-locking device of FIG. 1.

As shown from FIG. 1 to FIG. 5, an automatic-alarming push-down type emergency door-locking device 100 (the emergency door-locking device hereinafter) is disposed at a door board 200. The door board 200 includes a locking side 201 neighboring to at least one locking groove (only one locking groove LG shown in this embodiment). The locking groove LG can be provided to a door-frame lock seat 300, and the door-frame lock seat 300 is fixed to an indoor side 401 of a door frame 400. The number of the locking grooves is corresponding to that of the locking elements, and can be 1, 2 or 3.

The emergency door-locking device 100 includes a main lock seat 1, a secondary lock seat 2, a push-down type handle assembly 3, a position-sensing module 4, an alarm module 5, an alarm on/off lock 6, a lever 7 and an on/off position-detecting module 8.

The main lock seat 1 is disposed by being neighboring to the locking side 201 of the door board 200, and has at least one locking element (only one locking element 11 in this embodiment). The number of the locking elements can be determined according to different types of locks, such as single locking point, double locking point and three locking point, and can be 1, 2 or 3, and the locking element 11 can be a tongue, a latch or a crash bar. The secondary lock seat 2 is disposed by being farther away from the locking side 201 than the main lock seat 1. The push-down type handle assembly 3 includes a first handle 31, a second handle 32 and a push-down horizontal bar 33.

The first handle 31, connected pivotally with the secondary lock seat 2, can include a first drive portion 311 and a first operation portion 312. The first drive portion 311 is disposed inside the secondary lock seat 2. The first operation portion 312 is extended out of the secondary lock seat 2 from the first drive portion 311, and connected fixedly with the push-down horizontal bar 33. The second handle 32, connected pivotally with the main lock seat 1, can include a second drive portion 321 and a second operation portion 322. The second drive portion 321 is disposed inside the main lock seat 1. The second operation portion 322 is extended out of the main lock seat 1 from the second drive portion 321, and connected fixedly with the push-down horizontal bar 33.

The second drive portion 321 can be used to drive the unlocking mechanism so as to control the locking element 11 to protrude or retrieve. Since the unlocking mechanism is already one of popular driving mechanisms in the art (definitely modified to meet versatile locks, and generally consisted of rocker arms, linkages and resilient elements), not within the scope of this invention, thus detail thereabout would be omitted herein. The push-down horizontal bar 33 is to bridge fixedly the first operation portion 312 of the first handle 31 and the second operation portion 322 of the second handle 32, such that the second handle 32 and the first handle 31 can be connected in a coherent manner.

While in a locking state, since the first drive portion 311 and the second drive portion 321 are both disposed at a locking position LP, thus the unlocking mechanism can have the locking element 11 fitted into the locking groove LG to perform the locking. The position-sensing module 4, disposed inside the secondary lock seat 2, can include a first micro-switch sensor 41. While in the locking state, the first drive portion 311 would depress the first micro-switch sensor 41.

The alarm module 5, disposed inside the secondary lock seat 2, can include a circuit board 51, a controller 52 and a buzzer 53. The circuit board 51 is disposed inside the secondary lock seat 2, the controller 52 and the buzzer 53 are both disposed at the circuit board 51, and the controller 52 is connected electrically with the first micro-switch sensor 41 of the position-sensing module 4.

The alarm on/off lock 6 is extended out of the secondary lock seat 2 from an inside of the secondary lock seat 2, and furnished with a key hole KH and a protrusion 61. The lever 7, disposed inside the secondary lock seat 2, is furnished with a concave edge N for receiving the protrusion 61. The on/off position-detecting module 8, disposed inside the secondary lock seat 2, includes a second micro-switch sensor 81. The second micro-switch sensor 81 is connected electrically with controller 52.

While the protrusion 61 of the alarm on/off lock 6 is disposed at a function-off position FDP (as shown in FIG. 4), the on/off position-detecting module 8 does not contact the second micro-switch sensor 81, and thus the controller 52 of the emergency door-locking device 100 is in a (alarm) function-off state.

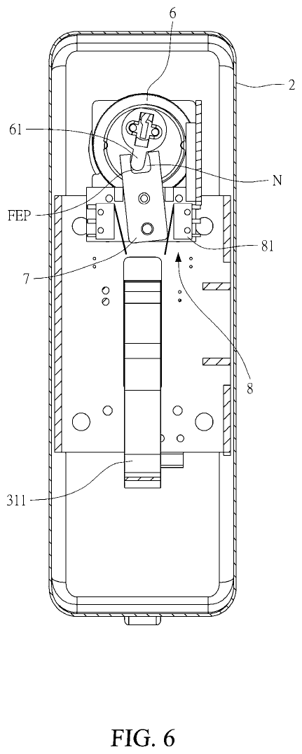

Referring to FIG. 6, the state of the automatic-alarming push-down type emergency door-locking device of FIG. 1 at a function on state of the alarm is illustrated schematically. Referring back to FIG. 1 and FIG. 2. While a key 500 is inserted into the key hole KH to rotate the alarm on/off lock 6, the protrusion 61 of the alarm on/off lock 6 would be switched to a function-on position FEP from the function-off position FDP shown in FIG. 4. At this time, the protrusion 61 can rotate the lever 7 to touch the second micro-switch sensor 81, so that the on/off position-detecting module 8 can detect that the protrusion 61 of the alarm on/off lock 6 is at the function-on position FEP. Then, a function-on signal S1 would be transmitted to the controller 52 for the controller 52 of the emergency door-locking device 100 to enter a (alarm) function-on state.

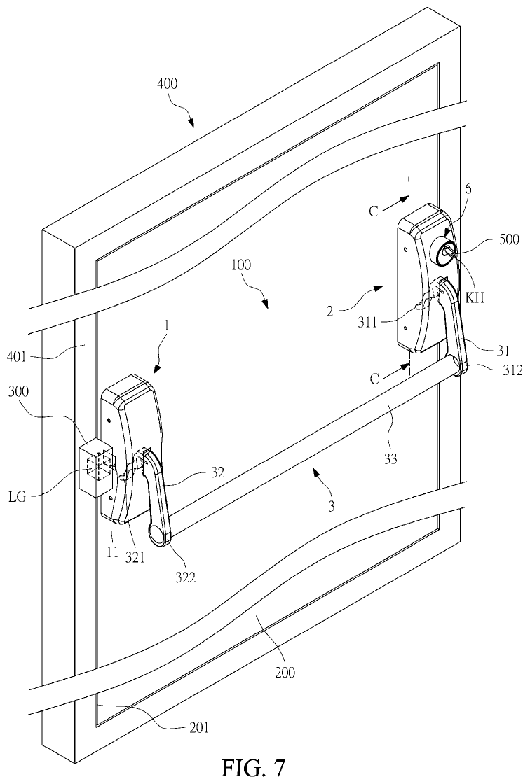

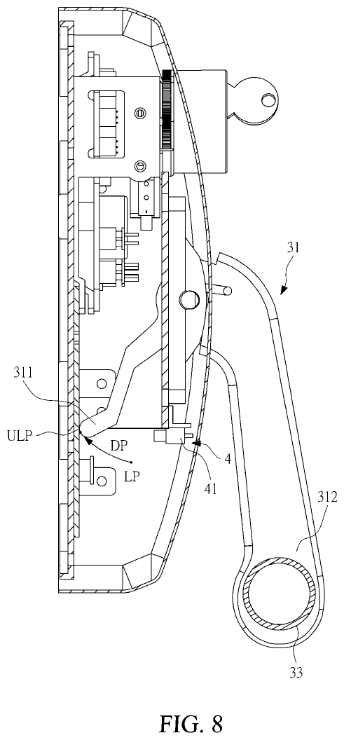

Refer FIG. 7 and FIG. 8; where FIG. 7 illustrates schematically the state of the automatic-alarming push-down type emergency door-locking device of FIG. 1 at a controlled unlock state after being assembled behind the emergency door, and FIG. 8 is a schematic cross-sectional view of the automatic-alarming push-down type emergency door-locking device along line C-C of FIG. 7. Refer now to FIG. 1 to FIG. 5 together. While the first handle 31, the second handle 32 or the push-down horizontal bar 33 of the push-down type handle assembly 3 are pushed down, then the first drive portion 311 of the first handle 31 would move along a driving path DP toward an unlocking position ULP of FIG. 8 from a locking position LP of FIG. 3. Simultaneously, the second drive portion 321 of the second handle 32 would follow the aforesaid operation to move the first handle 31 from the locking position LP along the driving path DP to approach the unlocking position ULP. As the unlocking position ULP is reached, the locking element 11 would be separated from the locking groove LG to perform the unlocking.

While the first drive portion 311 of the first handle 31 leaves off the locking position LP, the first drive portion 311 would be no longer to contact the first micro-switch sensor 41 of the position-sensing module 4, or to change the depression of the micro-switch sensor 41. At this time, the first micro-switch sensor 41 of the position-sensing module 4 would sense that the left of the first handle 31 away from the locking position LP, and then an alarm-triggering signal S2 would be transmitted. After the controller 52 of the alarm module 5 receives the alarm-triggering signal S2 in the function-on state, an alarm signal S3 would be generated and transmitted to the buzzer 53 for the buzzer 53 to form an alarm after receiving the alarm signal S3.

After the buzzer 53 activates the alarm, if the alarm is to be cancelled, then the key 500 can be inserted into the key hole KH to further rotate the alarm on/off lock 6, such that the protrusion 61 of the alarm on/off lock 6 would be switched back to the function-off position FDP from the function-on position FEP. At this time, the protrusion 61 can rotate the lever 7 without touching the second micro-switch sensor 81, such that the second micro-switch sensor 81 would detect that the protrusion 61 of the alarm on/off lock 6 is at the function-off position FDP, and a function-off signal S4 would be formed and transmitted to the controller 52 for the controller 52 to enter the function-off state again. Also, an alarm clear signal S5 would be generated and transmitted to the buzzer 53 for the buzzer 53 to terminate the alarm.

In summary, since the automatic-alarming push-down type emergency door-locking device 100 provided in the present invention utilizes the position-sensing module 4 disposed inside the secondary lock seat 2 to sense if the first handle 31 is separated from the locking position LP, such that the transmission of the alarm can be determined. In addition, since all the elements related to the aforesaid alarm means (including the position-sensing module 4 and the alarm module 5) are disposed inside the secondary lock seat 2, and all the mechanisms related to the locking/unlocking are also disposed inside the main lock seat, thus functions of automatic sensing and alarming can be fulfilled without changing internal locking/unlocking mechanisms of the main lock seat. Accordingly, the applications can be common for a variety of existing push-down emergency door-locking devices, and thus the push-down emergency door-locking device originally without the alarm function can be upgraded to have the alarm function. Thereby, preparation and installation costs of the components related to the sensing and alarming can be substantially reduced.

While the present invention has been particularly shown and described with reference to a preferred embodiment, it will be understood by those skilled in the art that various changes in form and detail may be without departing from the spirit and scope of the present invention.

What is claimed is:

1. An automatic-alarming push-down type emergency door-locking device, disposed at a door board, the door board including a locking side neighboring to at least one locking groove, comprising:
a main lock seat, disposed by neighboring to the locking side of the door board, having at least one locking element;
a secondary lock seat, disposed by being away from the locking side than the main lock seat;
a push-down type handle assembly, including:
a first handle, connected pivotally with the secondary lock seat, configured for being controlled to move pivotally toward an unlocking position along a driving path from a locking position;
a second handle, connected pivotally with the main lock seat, configured for being controlled to move with the first handle along the driving path; wherein, while at the locking position, the at least one locking element is buckled with the at least one locking groove; wherein, while at the unlocking position, the at least one locking element is separated from the at least one locking groove; and
a push-down horizontal bar, bridging the first handle and the second handle so as to have the second handle and the first handle to be connected in a coherent manner;
a position-sensing module, disposed at the secondary lock seat, configured for sensing whether or not the first handle has been separated from the locking position, and transmitting an alarm-triggering signal if positive; and
an alarm module, connected electrically with the position-sensing module inside the secondary lock seat, configured for issuing an alarm upon when the alarm-triggering signal is received in a function-on state.

2. The automatic-alarming push-down type emergency door-locking device of claim 1, wherein the first handle includes:
a first drive portion, disposed inside the secondary lock seat; and
a first operation portion, extending out of the secondary lock seat from the first drive portion, connected fixedly with the push-down horizontal bar.

3. The automatic-alarming push-down type emergency door-locking device of claim 2, wherein the second handle includes:
a second drive portion, disposed inside the main lock seat; and
a second operation portion, extending out of the main lock seat from the second drive portion, connected fixedly with the push-down horizontal bar.

4. The automatic-alarming push-down type emergency door-locking device of claim 1, wherein the position-sensing module includes a first micro-switch sensor for generating the alarm-triggering signal upon when it is detected that the first handle is separated from the locking position.

5. The automatic-alarming push-down type emergency door-locking device of claim 1, wherein the alarm module includes:
a circuit board, disposed inside the secondary lock seat;
a controller, disposed at the circuit board, connected electrically with the position-sensing module, configured for generating an alarm signal after the alarm-triggering signal is received in the function-on state; and
a buzzer, connected electrically with the controller, transmitting an alarm after the alarm signal is received.

6. The automatic-alarming push-down type emergency door-locking device of claim 5, further including:
an alarm on/off lock, disposed inside the secondary lock seat, driven by a key to move between a function-on position and a function-off position; and
an on/off position-detecting module, disposed at the secondary lock seat, connected electrically with the controller, configured for transmitting a function-on signal to the controller for the controller to enter the function-on state upon when the alarm on/off lock is detected to be at the function-on position, and for transmitting a function-off signal to the controller for the controller to enter a function-off state upon when the alarm on/off lock is detected to be at the function-off position, and then transmitting an alarm clear signal to the buzzer for terminating the alarm.

7. The automatic-alarming push-down type emergency door-locking device of claim 6, wherein the on/off position-detecting module includes a second micro-switch sensor for detecting that the alarm on/off lock is at the function-on position or the function-off position.

8. The automatic-alarming push-down type emergency door-locking device of claim 7, further including a lever, the lever being disposed inside the secondary lock seat and driven by the alarm on/off lock; wherein, upon when the alarm on/off lock is at the function-on position, the second micro-switch sensor is triggered to have the second micro-switch sensor to detect that the alarm on/off lock is at the function-on position.
